(19) United States
(12) Patent Application Publication
(10) Pub. No.: US 2003/0043916 A1
(43) Pub. Date: Mar. 6, 2003

(54) Signal adaptive spatial scaling for interlaced video

(75) Inventors: Zhun Zhong, Croton-On-Hudson, NY (US); Yingwei Chen, Briarcliff, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/946,717

(22) Filed: Sep. 5, 2001

(51) Int. Cl. H04N 7/12

(52) U.S. Cl. 375/240.24; 375/240.27

(57) ABSTRACT

The present invention is directed to method of scaling interlaced video. According to the present invention, the method includes an interlaced video frame being divided into blocks. Determining if any of the blocks correspond to a moving area in the interlaced video frame. Field-based scaling is performed on blocks corresponding to a moving area. Frame-based scaling is performed on blocks not corresponding to a moving area.

### BACKGROUND OF THE INVENTION

The present invention relates generally to video processing, and more particularly, to a signal adaptive spatial scaling for interlaced video that applies field-based scaling to moving areas and frame-based scaling to the other areas.

Video compression incorporating a discrete cosine transform (DCT) and motion prediction is a technology that has been adopted in multiple international standards such as MPEG-1, MPEG-2, MPEG-4, and H.262. Among the various DCT/motion prediction video coding schemes, MPEG-2 is the most widely used, in DVD, satellite DTV broadcast, and the U.S. ATSC standard for digital television.

In some applications, it may be desirable to scale the video before it is displayed. An example of such an application is shown in FIG. 1. As can be seen, the decoder includes a first path made up of a variable-length decoder (VLD) 2, an inverse-scan and inverse-quantization (ISIQ) unit 4 and an inverse discrete cosine transform (IDCT) unit 6. A second path is included made up of the VLD 2, ½ pixel motion compensation unit 10 and a frame store 12. An adder 8 is also included to combine the outputs from the first and second paths to produce output video.

Further, an external scaler 14 is coupled to the output of the adder 8 to scale the output video to the desired display resolution. This is usually done in either the horizontal or vertical direction. In most cases, scaling consists of filtering and then sub-sampling, however, in some cases, direct sub-sampling is an option.

### SUMMARY OF THE INVENTION

The present invention is directed to method of scaling interlaced video. According to the present invention, the method includes an interlaced video frame being divided into blocks. Determining if any of the blocks correspond to a moving area in the interlaced video frame. Field-based scaling is performed on blocks corresponding to a moving area. Frame-based scaling is performed on blocks not corresponding to a moving area.

The present invention is directed to method of decoding interlaced video. According to the present invention, the method includes producing a residual error frame and a motion compensated frame. The residual error frame and the motion compensated frame are then combined to produce an interlaced video frame. Field-based scaling is performed on at least one area corresponding to movement in the interlaced video frame and frame-based scaling is performed on areas not corresponding to movement in the interlaced video frame.

### BRIEF DESCRIPTION OF THE DRAWINGS

Referring now to the drawings were like reference numbers represent corresponding parts throughout:

FIG. 1 is a block diagram of one example of a MPEG-2 decoder with an external scaler;

FIG. 2 is a block diagram of one example of a decoder according to the present invention;

FIG. 3 is a flow diagram of one example of the signal adaptive spatial scaling for interlaced video according to the present invention;

FIG. 4 is one example of a data block that represents a moving area in interlaced video;

FIG. 5 is one example of pseudo-code for detecting moving areas in interlaced video according to the present invention; and

FIG. 6 is a block diagram of one example of a system according to the present invention.

### DETAILED DESCRIPTION

As previously described, in some applications, it may be desirable to scale the video before it is displayed. In interlaced video, each frame consists of two fields that are one field apart temporally. Therefore, scaling can be performed on either a field or frame basis for interlaced video.

Presently, two approaches for performing scaling on interlaced video are known. One approach only applies frame-based scaling to each interlaced video frame, while the other approach only applies field-based scaling. However, both of these approaches present some problems.

In frame-based scaling, all of the lines of an interlaced frame including both fields are filtered to eliminate high frequency components and then sub-sampled at one time. However, this causes problems when there is movement in an interlaced video frame. In the areas of the interlaced frame that includes this movement, there are significant differences between the two fields, which translates into high frequencies. Thus, by filtering all of the lines of each frame, the high frequencies due to these moving areas are destroyed. This is undesirable since it often causes the moving objects to have jittery edges.

In field-based scaling, the lines of each field of an interlaced framed are separately filtered and sub-sampled at a time. Thus, this preserves the high frequency components due to moving areas. However, this causes problems in stationary areas. First of all, this approach enables other undesirable high frequency components such as noise to pass through, which may result in aliasing. Also, this approach may also filter out desirable low frequency components, which may result in a blurred picture.

In order to avoid the above-described problems, the present invention is directed to signal adaptive spatial scaling for interlaced video. According to the present invention, field-based scaling is applied to areas of the interlaced frame that have significant differences between the two fields due to movement. While frame-based scaling is applied to the other areas.

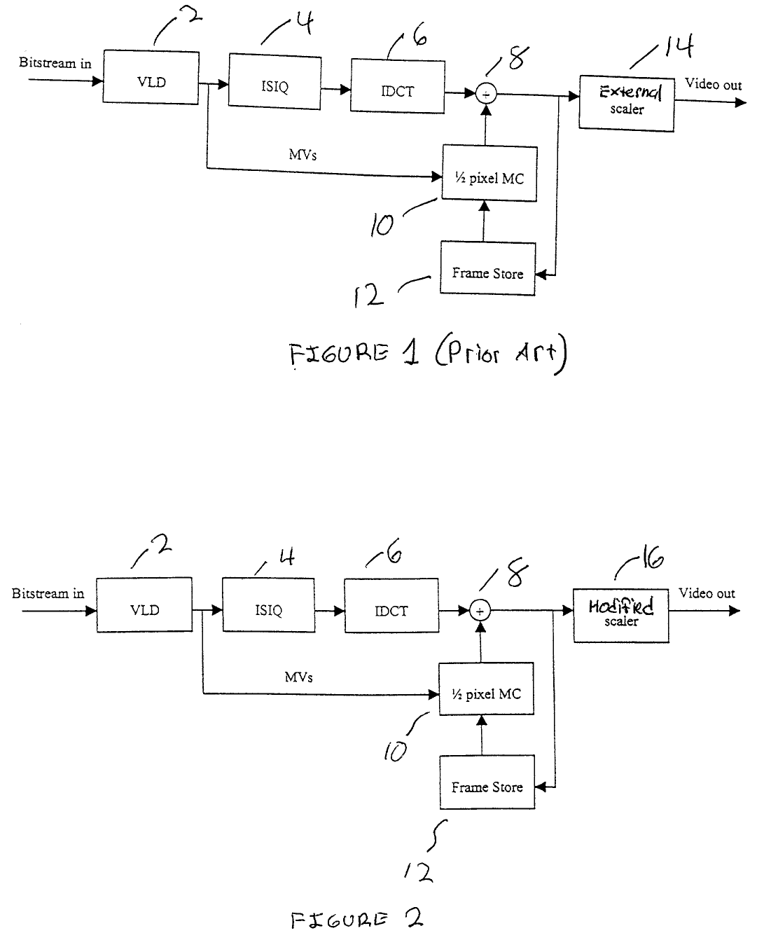

One example of a decoder according to the present invention is shown in FIG. 2. As can be seen, the decoder according to the present invention is the same as FIG. 1 except for the modified scaler 16. As in FIG. 1, the decoder includes a first path 2,4,6 for producing intra-coded frames and residual error frames, and a second path 2,10,12 for producing motion compensated frames. An adder 8 is also included to combine the outputs of the first and second paths to produce interlaced video.

Also, during operation, the modified scaler 16 scales the interlaced video to the display resolution. Thus, the modified scaler 16 will either up-scale or down-scale the vertical resolution of the interlaced video depending on the particular application. In one application, the modified scaler 16 downscales the vertical resolution by a factor of two. However, the present invention differs in that the modified scaler 16 performs field-based scaling on the moving areas in each interlaced video frame and frame-based scaling on the other areas.

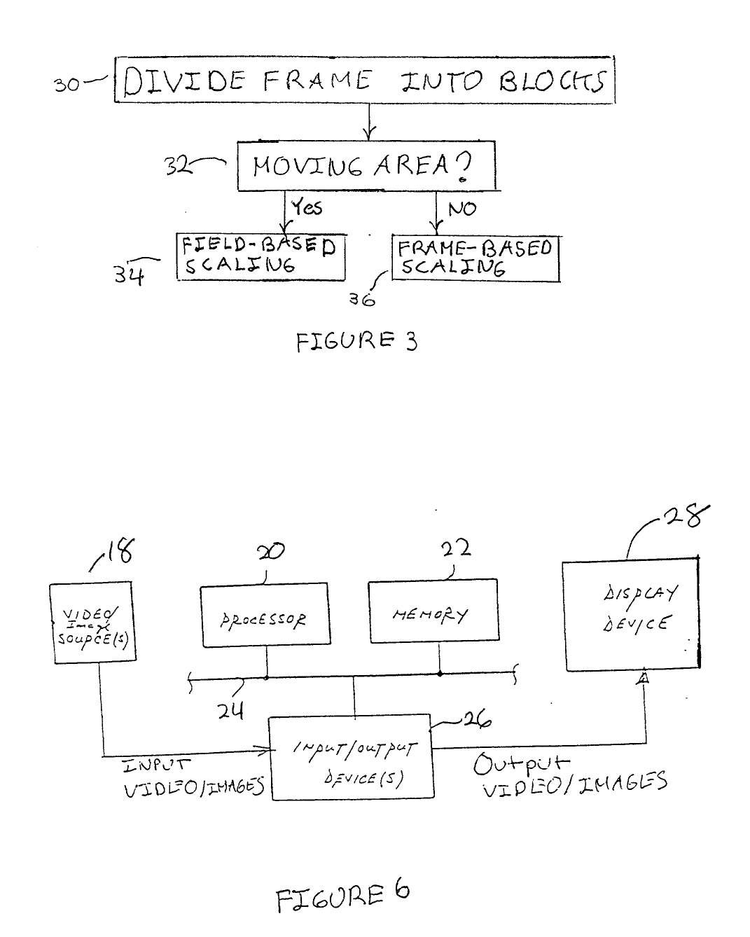

One example of the signal adaptive spatial scaling performed by the modified scaler 16 is shown in FIG. 3. In step 30, each interleaved video frame is divided into blocks. In one example, each interlaced video frame is divided into 16×16 blocks, which is the size of an MPEG-2 Macroblock.

In step 32, it is determined if any blocks correspond to a moving area in the interlaced video frame. As previously described, there are significant differences between the two fields in the area where there is movement. An example of this is shown in FIG. 4. In this block, the dark rows represent the top field while the lighter one represents the bottom field. As can be seen, there is a significant difference between the two fields. Therefore, by taking the difference between the two fields, a large value will be produced indicating that this particular area is a moving area.

In view of the above, in order to identify a moving area in step 32, the difference between the two fields is calculated. If the difference is small, then the area is not a moving area. If the difference is large, then the area is a moving area.

In step 34, field-based scaling is performed on the blocks determined to correspond to a moving area in step 32. As previously described, in field-based scaling, the lines of each field are separately filtered and sub-sampled. In step 36, frame-based scaling is performed on the blocks not determined to correspond to a moving area in step 32. As previously described, in frame-based scaling, all of the lines of an interlaced frame including both fields are filtered and then sub-sampled.

In both steps 34 and 36, the filtering performed eliminates high frequency components. Further, the sub-sampling performed is at a predetermined rate such as a factor of two, four, . . . etc.

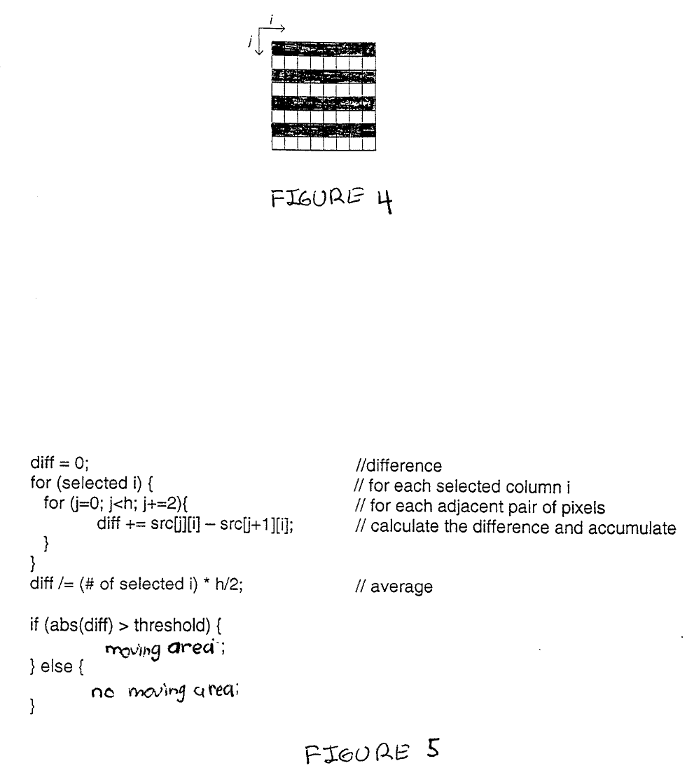

One example of a pseudo-code for performing step 32 of FIG. 3 is shown in FIG. 5. In the first line, a variable “diff” is initially set to zero. In the fourth line, the difference between the two fields of a data block is calculated. As can be seen, the difference between adjacent pixels (j,j+1)of the two fields is calculated and accumulated for each column (i) of the data block selected in line 2. It should be noted that the difference taken is not the absolute difference. It should also be noted that the more columns (i) selected in line 2, a more accurate detection will be obtained. However, in order reduce computations, a limited number of columns (i) may be selected in line 2. For example, only the first, last column, middle or every third column (i) may be selected to perform this detection.

In the fifth line, the difference (diff) is then averaged. This is necessary in order to scale the difference (diff) to the threshold in the sixth line. In this example, the average is calculated by dividing the difference (diff) by the number of columns (i) selected and the number of pairs of pixels (h/2) in each column.

In the sixth line, the absolute value of the difference abs(diff) is then compared to a threshold. In this example, the threshold would be for the difference between one pair of pixels such as twenty (20). If the abs(diff) exceeds the threshold, this indicates that a moving area has been detected. If the abs(diff) does not exceed the threshold, this indicates that a moving are was not detected.

One example of a system in which the signal adaptive spatial scaling according to the present invention may be implemented is shown in FIG. 6. By way of example, the system may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system includes one or more video sources 18, one or more input/output devices 26, a processor 20 and a memory 22.

The video/image source(s) 18 may represent, e.g., a television receiver, a VCR or other video/image storage device. The source(s) 18 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 26, processor 20 and memory 22 communicate over a communication medium 24. The communication medium 24 may represent, e.g., a bus, a communication network, one or more internal connections of a circuit, circuit card or other device, as well as portions and combinations of these and other communication media. Input video data from the source(s) 18 is processed in accordance with one or more software programs stored in memory 22 and executed by processor 20 in order to generate output video/images supplied to a display device 28.

In one embodiment, the signal adaptive spatial scaling is implemented by computer readable code executed by the system. The code may be stored in the memory 22 or read/downloaded from a memory medium such as a CD-ROM or floppy disk. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. For example, the present invention has been described using the MPEG framework. However, it should be noted that the concepts and methodology described herein is also applicable to any DCT/notion prediction schemes, and in a more general sense, any frame-based video compression schemes where picture types of different inter-dependencies are allowed. Therefore, the present invention is intended to cover various structures and modifications thereof included within the spirit and scope of the appended claims.

What is claimed is:

1. A method for scaling interlaced video, the method comprising the steps of:
dividing an interlaced video frame into blocks;
determining if any of the blocks correspond to a moving area in the interlaced video frame;
performing field-based scaling on blocks corresponding to a moving area; and
performing frame-based scaling on blocks not corresponding to a moving area.

2. The method of claim 1, wherein the blocks are 16×16 blocks.

3. The method of claim 1, wherein the determining if any blocks correspond to a moving area includes:
calculating a difference between two fields for each of the blocks;
calculating an absolute value of the difference between two fields; and
comparing the absolute value of the difference between the two fields to a predetermined threshold.

4. The method of claim 3, wherein the difference between the two fields is calculated by accumulating the difference between adjacent pixels of the two fields in at least one column of the blocks.

5. A memory medium including code for scaling interlaced video, the code comprising:
a code for dividing an interlaced video frame into blocks;
a code for determining if any of the blocks correspond to a moving area in the interlaced video frame;
a code for performing field-based scaling on blocks corresponding to a moving area; and
a code for performing frame-based scaling on blocks not corresponding to a moving area.

6. A method for decoding interlaced video, comprising the steps of:
producing a residual error frame;
producing a motion compensated frame;
combining the residual error frame and the motion compensated frame to produce an interlaced video frame; and
performing field-based scaling on at least one area corresponding to movement in the interlaced video frame; and
performing frame-based scaling on areas not corresponding to movement in the interlaced video frame.

7. A memory medium including code for decoding interlaced video, the code comprising:
a code for producing a residual error frame;
a code for producing a motion compensated frame;
a code for combining the residual error frame and the motion compensated frame to produce an interlaced video frame; and
a code for performing field-based scaling on at least one area corresponding to movement in the interlaced video frame; and
a code for performing frame-based scaling on areas not corresponding to movement in the interlaced video frame.

8. A decoder for decoding interlaced video, comprising:
a first path for producing a residual error frame;
a second path for producing a motion compensated frame;
an adder for combining the residual error frame and the motion compensated frame to produce an interlaced video frame; and
a scaler for performing field-based scaling on at least one area corresponding to movement in the interlaced video frame and for performing frame-based scaling on areas not corresponding to movement.
